(19) United States
(12) Patent Application Publication
(10) Pub. No.: US 2018/0132467 A1
(43) Pub. Date: May 17, 2018

(54) COMBINATION AERATION AND FISHING HOLE DEICING APPARATUS

(71) Applicant: Maurice Sporting Goods, Inc., Northbrook, IL (US)

(72) Inventors: Greg Marchione, Volo, IL (US); Trevor Bending, Winchester, IL (US)

(21) Appl. No.: 15/350,806

(22) Filed: Nov. 14, 2016

(51) Int. Cl. A01K 97/01

(52) U.S. Cl. CPC A01K 97/01

(57) ABSTRACT

A combination aeration and fishing hole deicing apparatus has a housing that is substantially egg-shaped, buoyant, and weighted with its contents towards the bottom of the housing, such that, when placed in water, the apparatus floats with a portion of the housing being submerged below the waterline. The egg shape of the housing promotes axial precession, or wobbling of the housing about its vertical axis while in operation. The egg-shape of the housing and precession promote relatively random lateral movement of the housing within the water in which it is placed, thereby serving to preclude an ice fishing hole in which the apparatus is placed from freezing shut. The apparatus may alternatively be placed in a bait bucket, aerating the surrounding water to aid in keeping bait fish alive until needed.

### BACKGROUND OF THE INVENTION

### 1. Field of the Invention

The present invention relates, in general, to fishing equipment and, more particularly, to apparatuses for aerating a body of water, and for precluding ice fishing holes from icing over.

### 2. General Background of the Invention

Fishing has become a tremendously popular sport. In a national survey conducted by the U.S. Fish and Wildlife Service, an estimated 33.1 million U.S. residents 16 years of age or older participated in fishing in the year 2011, spending an estimated $41.8 billion in fishing-related expenses during that year.

One popular form of bait used in fishing is live bait, such as minnows. To assist in keeping minnows alive prior to their use as live bait, it is often desirable to aerate the water in which they are kept, typically within a portable bait bucket.

In winter months, ice and spear fishing are quite popular in the northern climes. Both involve drilling a hole through the ice in a frozen lake in which to fish through from the surface. As ice and spear fishing can often take many hours, there is a risk, particularly in colder weather, that the ice fishing hole will freeze over again while in use, precluding further fishing activity until the fishing hole is again cleared or enlarged.

### BRIEF SUMMARY OF THE INVENTION

The present invention comprises a miniature, combination aeration and fishing hole deicing apparatus. The apparatus is preferably self-contained within a single housing, which houses an internal power source, an electric motor and an air pump. A power switch, accessible from the housing's exterior, allows a user to turn the unit on and off. An oxygenation stone, coupled to an output port of the air pump and disposed on the bottom surface of the housing, distributes air bubbles into a body of water in which the apparatus is placed when in operation.

The apparatus, and particularly its housing, is preferably substantially egg-shaped, buoyant, handheld in size, and weighted with its contents towards the bottom of the housing, such that, when placed in water, the apparatus floats with slightly more than half of the housing being submerged below the waterline. In operation, the egg-shape of the housing is considered to promote axial precession, or wobbling of the housing about its vertical axis when the apparatus is floating in water. The wobbling or precession, in turn, is further considered to promote lateral movement of the housing within the water in which it is placed and floating. By placing the apparatus into an open ice fishing hole, the apparatus will tend to wobble and to move about the hole in a relatively random fashion, thereby serving to maintain the hole opening and preclude the hole from icing shut again. Moreover, the apparatus may alternatively be placed in a bait bucket, aerating the surrounding water to aid in keeping bait fish kept therein alive until needed.

### BRIEF DESCRIPTION OF THE SEVERAL VIEWS OF THE DRAWINGS

FIG. 1 is a side view of the combination aeration and fishing hole deicing apparatus of the present invention;

FIG. 2 is a top view of the present combination aeration and fishing hole deicing apparatus;

FIG. 3 is a bottom view of the present combination aeration and fishing hole deicing apparatus;

FIG. 4 is a side view of the present combination aeration and fishing hole deicing apparatus, with the top and bottom shells of the housing being separated to show the internal components therein;

FIG. 5 is a top perspective view of the bottom shell of the housing;

FIG. 6 is a top perspective view of the top shell of the housing;

FIG. 7 is a side view of the rotary on/off knob;

FIG. 8 is a side view of the fishing line eyelet;

FIG. 9 is a side view of the battery compartment;

FIG. 10 is an electrical and pneumatic schematic diagram of the present combination aeration and fishing hole deicing apparatus; and

FIG. 11 is a side view of the combination aeration and fishing hole deicing apparatus, showing, in particular, its buoyancy when placed in a body of water.

### DETAILED DESCRIPTION OF THE INVENTION

While the present invention is susceptible of embodiment in many different forms, there is shown in the drawings and will herein be described in detail, one specific embodiment, with the understanding that the present disclosure is intended as an exemplification of the principles of the present invention and is not intended to limit the invention to the embodiment illustrated.

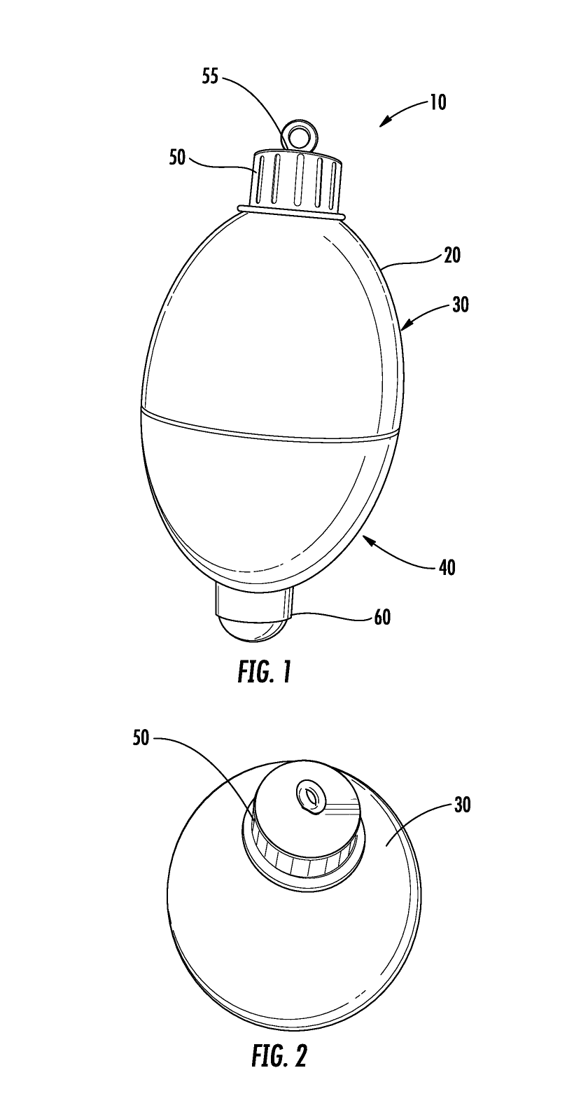

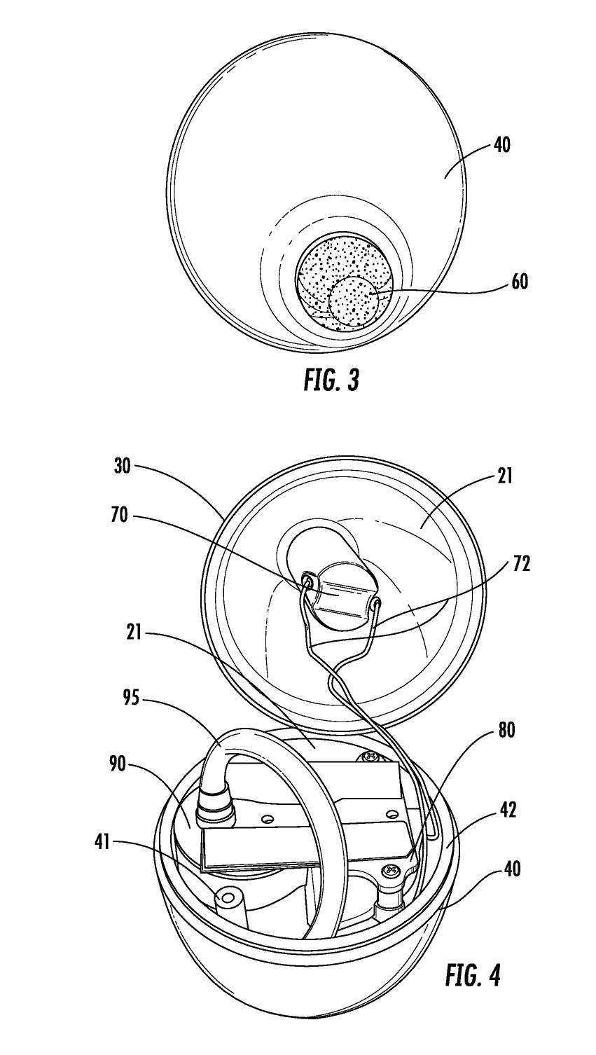

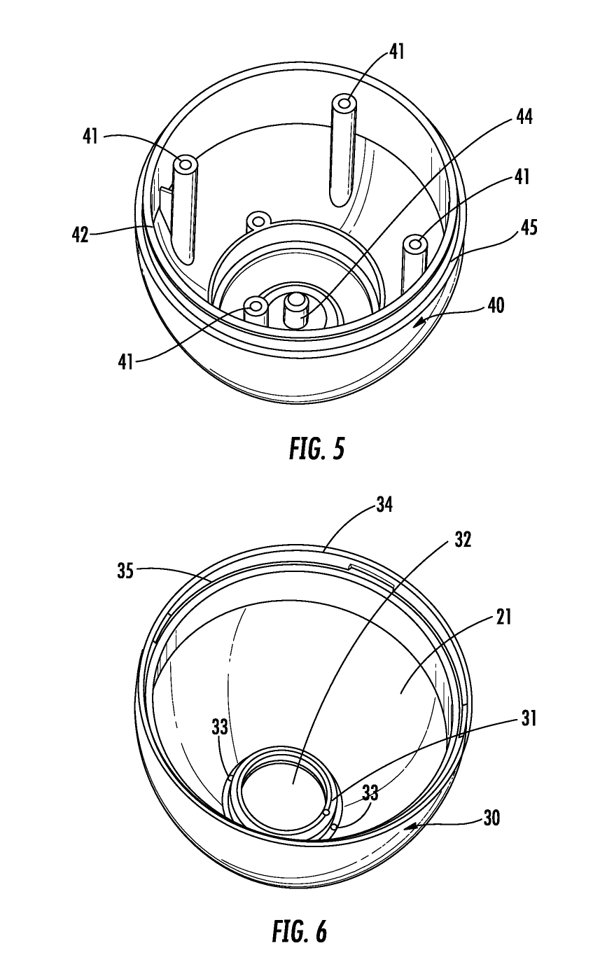

An embodiment of the present combination aeration and fishing hole deicing apparatus 10 is shown in FIGS. 1-9 as comprising housing 20, rotary knob 50, which serves as an electrical on/off switch for the overall apparatus 10, and oxygenation stone 60. Housing 20 comprises upper shell 30 and lower shell 40 which, when jointed together, form a substantially watertight interior 21. In particular, upper shell 30 of housing 20 includes upper collar 31 having aperture 32 for the threaded attachment of battery housing 70 within interior 21, and lower collar 34 about which threads 35 are disposed for the threaded attachment of lower shell 40. As best seen in FIG. 6, upper shell 30 includes two small inlet ports 33 disposed on opposing sides of collar 31, permitting fresh air to be drawn into the interior 21 of housing 20 to, in turn, serve as a source of input air for air pump 90.

Lower shell 40 of housing 20 comprises mounting posts 41 for mounting various internal components including electric motor 80 and air pump 90, collar 43 having threads 43 and washer 45 for the threaded engagement and substantially watertight attachment of lower shell 40 to upper shell 30, and hose coupling 44, serving to couple air hose 95 to oxygenation stone 60, thereby providing a conduit for the air output from air pump 90 to be expelled from interior 21 of housing 20. Oxygenation stone 60 is a porous member such as, for example, a stone having a pore size in the range of two to five microns.

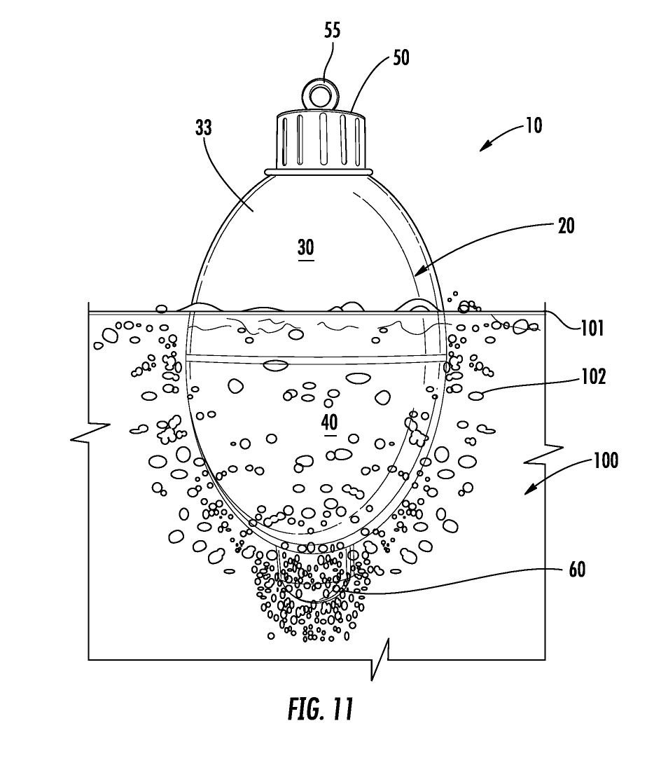

As best seen in FIGS. 1 and 11, housing 20 is substantially egg-shaped. As used herein, “egg-shaped” means having a shape that is approximated by a “long” half of a prolate spheroid, joined to a “short” half of a roughly spherical ellipsoid, or even a slightly oblate spheroid. These are joined at the equator and share a principal (longitudinal) axis of rotational symmetry. Although the term egg-shaped usually implies a lack of reflection symmetry across the equatorial plane, as used herein it may also refer to true prolate ellipsoids.

The egg-shape of housing 20 is considered to promote axial precession, or wobbling of housing 20 about its vertical axis. The egg-shape and wobbling or precession are further considered to in turn promote lateral movement of housing 20 within the water in which it is placed. By placing the apparatus 10 into an open ice fishing hole, the apparatus will tend to wobble and to move about the hole in a relatively random fashion, thereby serving to maintain the hole opening and preclude the hole from freezing shut. Moreover, apparatus 10 may alternatively be placed in a bait bucket, aerating the surrounding water to aid in keeping bait fish kept therein alive until needed. The compact, handheld size of apparatus 10, which preferably operates using a single standard AA battery, facilitates its transport within a tackle box or other convenient carrier for use when needed.

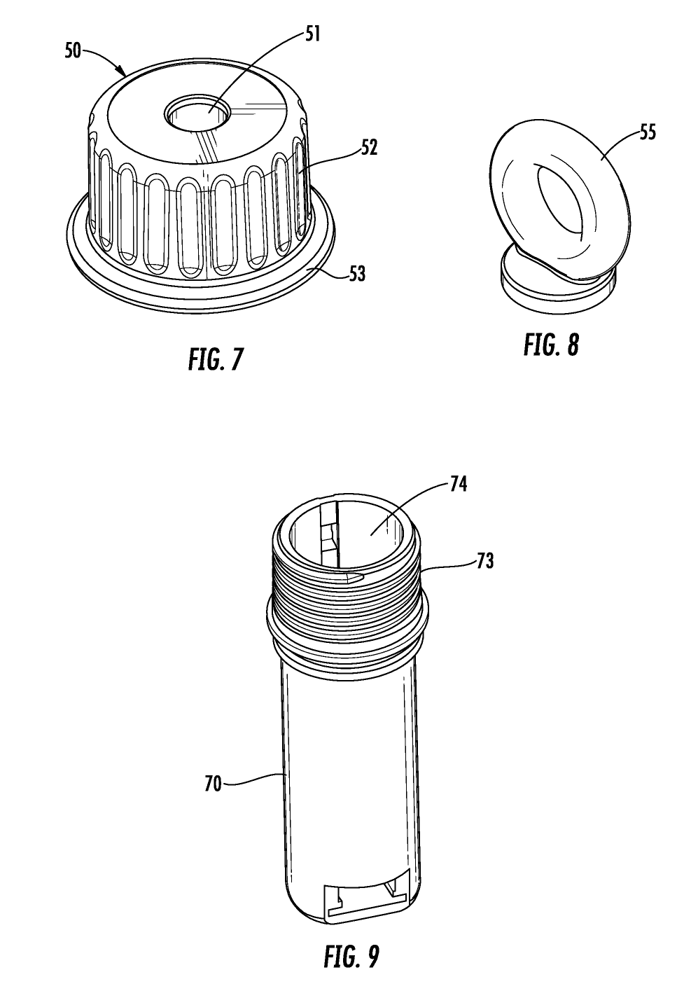

As shown in FIG. 7, rotary knob 50, which serves as a manual on-off switch for apparatus 10, comprises eyelet attachment aperture 51, gripping region 42, and collar 53. Eyelet attachment aperture 51 receives eyelet 55 for attachment to the top surface of rotary knob 50, enabling one or more fishing lines to optionally be used to secure apparatus 10 proximate a desired location with an associated bait bucket or ice fishing hole. Collar 53 has internal threads for mating attachment with a portion of collar 73 of battery compartment 70, with a portion of collar 73 extending outwardly through the top surface of upper shell 30 upon such attachment. The threaded removal and attachment of rotary knob 50 from the outwardly extending portion of collar 73 of battery compartment 70 enables a power source, such as, for example, a conventional 1.5 volt AA battery, to be inserted and removed through top aperture 74 of battery compartment 70.

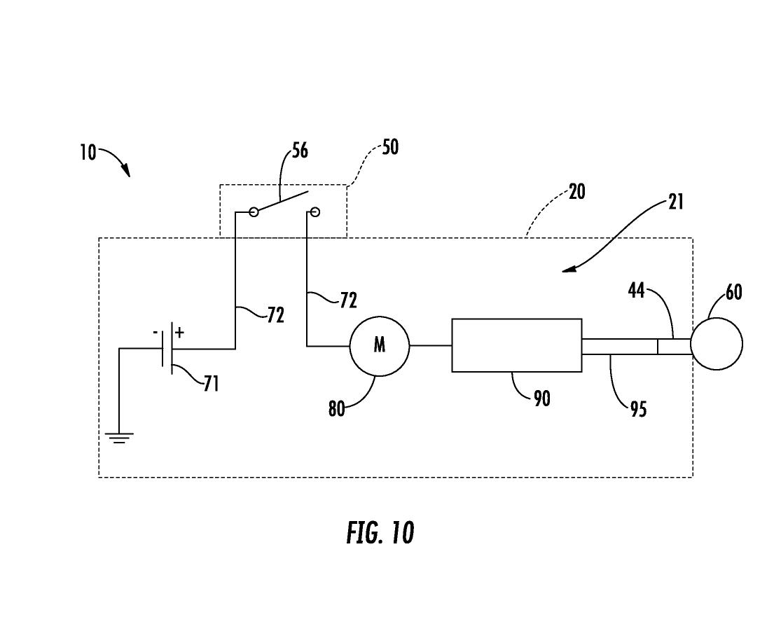

Referring to FIG. 10, the electrical and pneumatic components of the present combination aeration and fishing hole deicing apparatus 10 are shown as comprising battery 71, power switch 56 (controlled by rotary knob 50), electric motor 80, air pump 90, air hose 95, hose coupling 44 and aerating stone 60. Apart from rotary knob 50 and aerating stone 60, all of the electrical and pneumatic components of apparatus 10 are disposed within interior 21 of housing 20. Battery 71 may comprise, for example, a conventional 1.5 volt AA battery. Power switch 56 may be a single pole, single throw switch, which transitions between the closed and open positions upon the manual turning of rotary knob 50 in the clockwise and counterclockwise directions, respectively. In particular, leads or wires 72 carry electric power from battery 71 to motor 80 via switch 56. Electric motor 80 may comprise, for example, a miniature 1.5 volt direct current motor. Rotation of a shaft driven by electric motor 80, in turn, causes air pump 90 to continuously draw in ambient air within interior 21 of housing 20, which enters through inlet ports 33 of upper shell 30, and to output a stream of air into a first end of air hose 95, which may comprise, for example, a flexible tubing constructed of nylon or other suitable material. A second, opposing end of air hose 95 is coupled to hose coupling 44, which extends through lower shell 40 and permits the stream of air output from pump 90 to be expelled from interior 21 of housing 20. As shown in FIG. 10, oxygenation stone 60 may be coupled directly to an opposing end of hose coupling 44, thereby dispersing air from pump 90 immediately as it exits interior 21 of housing 20. Alternatively, an auxiliary hose, such as a length of flexible tubing, may be connected between hose coupling 44 and oxygenation stone 60, enabling oxygenation stone 60 to dispense air at a distance from housing 20. This configuration may be desirable, for instance, within a relatively tall bait bucket, enabling air to be dispersed proximate the bottom service of the container, rather than closer to the top surface of the water disposed therein.

The present combination aeration and fishing hole deicing apparatus 10 is shown in operation in FIG. 11. The components within housing 20 have an aggregate weight, and are so distributed within interior 21 of housing 20, such that apparatus 10 is buoyant within a volume of water 100, and floats with bottom shell 40 and a portion of top shell 30 being disposed beneath surface 101 of water 100. In this manner, oxygenation stone 60 remains below surface 101 of water 100, while rotary knob 50, eyelet 51, and air inlet ports 33 remain above surface 101 of water 100. When apparatus 10 is powered, air will be drawn from above surface 101 of water 100, drawn through inlet ports 33 into interior 21 of housing 20, and expelled below surface 101 of water 100 by oxygenation stone 60, in the form of a plurality of air bubbles 102.

Many modifications and variations of the present invention are possible in light of the above teachings. It is therefore to be understood that within the scope of the appended claims, the invention may be practiced other than as specifically described. Various modifications, changes and variations may be made in the arrangement, operation and details of construction of the invention disclosed herein without departing from the spirit and scope of the invention. The present disclosure is intended to exemplify and not limit the invention.

What is claimed is:

1. a combination aeration and fishing hole deicing apparatus, comprising:
an egg-shaped housing;
at least one air inlet disposed through the housing and permitting external air to be drawn from a region outside the egg-shaped housing into an interior of the egg-shaped housing;
an air pump disposed within the egg-shaped housing; and
at least one air outlet disposed through the egg-shaped housing and permitting air output from the air pump to be dispersed from the egg-shaped housing into a body of water.

2. The invention according to claim 1, wherein the apparatus is buoyant and floats upon the body of water when the apparatus is placed in the body of water.

3. The invention according to claim 2, wherein a first portion of the egg-shaped housing remains submerged below a surface of the body of water and a second portion of the egg-shaped housing remains above the surface of the body of water when the apparatus is placed in the body of water.

4. The invention according to claim 2, wherein the egg-shaped housing wobbles or precesses when the apparatus is operated in the body of water.

5. The invention according to claim 1, wherein the apparatus further includes a porous air dispersing member disposed proximate a bottom surface of the egg-shaped housing.

6. The invention according to claim 1, wherein the porous air dispersing member comprises an oxygenation stone.

7. The invention according to claim 1, wherein the apparatus further includes an on/off switch disposed proximate a top surface of the egg-shaped housing.

8. The invention according to claim 1, wherein the apparatus further includes an air pump disposed within the interior of the egg-shaped housing.

9. The invention according to claim 8, wherein the air pump is electrically actuated.

10. The invention according to claim 8, wherein the apparatus further includes a motor powering the air pump.

11. The invention according to claim 1, further comprising an eyelet disposed proximate a top surface of the egg-shaped housing.
